(19) United States
(12) Patent Application Publication
(10) Pub. No.: US 2026/0216923 A1
(43) Pub. Date: Jul. 30, 2026

(54) A METHOD FOR RETRIEVING A RECYCLABLE FIBRE MAT FROM AN EPOXY COMPOSITE STRUCTURE

(71) Applicant: VESTAS WIND SYSTEMS A/S, Aarhus N (DK)

(72) Inventors: Jesper Rømer HANSEN, Risskov (DK); Mie REHMEIER, Sabro (DK)

(21) Appl. No.: 19/146,996

(22) PCT Filed: Jan. 31, 2024
(86) PCT No.: PCT/DK2024/050016

§ 371 Date: Jul. 10, 2025

(30) Foreign Application Priority Data
Jan. 31, 2023 (DK) PA202370052

(51) Int. Cl. B29B 17/02

(52) U.S. Cl. CPC B29B 17/02; B29B 2017/0296

(57) ABSTRACT

A method for retrieving a recyclable fibre mat (13) from an epoxy composite structure (6, 6a) is disclosed An epoxy composite structure (6, 6a), e.g. a wind turbine blade (6), made from a composite material comprising at least one fibre mat (13) embedded in a matrix of epoxy resin (14) is provided. The epoxy composite structure (6, 6a) is exposed to a release agent (11), e.g. comprising acid, such as formic acid, causing disintegration of the epoxy composite structure (6, 6a). The at least one fibre mat (13) is retrieved from the disintegrated epoxy composite structure (6, 6a). A recycled fibre mat (13) comprising epoxy particles chemically and/or mechanically bonded to the surface of the fibre mat is also disclosed.

### FIELD OF THE INVENTION

The present invention relates to a method for retrieving a recyclable fibre mat from an epoxy composite structure, such as a wind turbine blade. The method according to the invention allows the retrieved fibre mats to be reused directly in new composite structures. The invention further relates to a fibre mat which has been retrieved by means of the method.

### BACKGROUND OF THE INVENTION

At the end of their lifetime, composite structures, such as wind turbine blades, need to be disposed of. This could, e.g., involve depositing the composite structure in a landfill, possibly after cutting the composite structure into smaller parts. In order to increase material efficiency and reduce or avoid landfill, there is a desire to at least partly recycle composite structures. However, due to the composite nature of these structures, it is difficult to separate the structures into their original constituent parts, and this renders appropriate recycling of material difficult, or even impossible. For instance, the composite structures may comprise fibres arranged in a matrix of a cured resin, e.g. an epoxy based resin.

Once cured, it is not possible to mechanically separate the fibres from the resin. One previous approach for recycling composite structures, such as epoxy composite structures, is to subject the composite structure to shredding or grinding, and subsequently performing a separation process on the shredded or grinded material, in order to for example use is for cement production (which means that the resin is combusted and lost as CO₂) or glue it together in a new geometry (which represents down cycling and later recycling is further complicated).

### DESCRIPTION OF THE INVENTION

It is an object of embodiments of the invention to provide a method for retrieving a recyclable fibre mat from an epoxy composite structure which allows for easy, cost effective and environment friendly recycling of the epoxy composite structure.

It is a further object of embodiments of the invention to provide a recyclable fibre mat which is suitable for reuse in a new high quality composite structure.

According to a first aspect the invention provides a method for retrieving a recyclable fibre mat from an epoxy composite structure, the method comprising the steps of:
providing an epoxy composite structure made from a composite material comprising at least one fibre mat embedded in a matrix of epoxy resin,
exposing the epoxy composite structure to a release agent causing disintegration of the epoxy composite structure, and
retrieving the at least one fibre mat from the disintegrated epoxy composite structure.

Thus, the first aspect of the invention provides a method for retrieving a recyclable fibre mat from an epoxy composite structure. In the present context, the term ‘composite structure’ should be interpreted to mean a structure which is made from a fibre mat containing composite material, i.e. a material which comprises suitable fibre mats embedded in a matrix of cured resin. In the present context the term ‘epoxy composite structure’ should be interpreted to mean a composite structure where the applied resin is an epoxy based resin.

In the method according to the first aspect of the invention, an epoxy composite structure as defined above is initially provided. Accordingly, the provided epoxy composite structure is made from a composite material comprising at least one fibre mat embedded in a matrix of epoxy resin, preferably cured epoxy resin.

The composite structure could, e.g., be a wind turbine blade or a part of a wind turbine blade, or it could originate from any other suitable kind of structure, which has reached its end of life.

In the present context the term ‘fibre mat’ should be interpreted to mean a substantially two-dimensional or sheet-like item made exclusively or primarily from fibres. Accordingly, the fibres of the composite structure are provided as such substantially two-dimensional or sheet-like items, rather than in the form of loose fibres embedded in the matrix of epoxy resin.

Next, the epoxy composite structure is exposed to a release agent, preferably a liquid release agent. This could, e.g., include partly or completely submerging the epoxy composite structure in a vessel or container accommodating the release agent. The release agent causes disintegration of the epoxy composite structure. This could, e.g., include swelling of epoxy polymers of the epoxy resin and/or dissolving of the epoxy resin. This will be described in further detail below. In any event, as a result of exposing the epoxy composite structure to the release agent, the composite structure disintegrates to the extent that the at least one fibre mat and the epoxy resin are separated, i.e. the at least one fibre mat is released from the matrix of epoxy resin. The disintegration of the epoxy composite structure typically leads to the most or all of the epoxy polymer being released, typically as swelled powder or dissolved in the release agent, from the other components of the composite including the fibre mats. For example, at least 80% of the epoxy polymer such as at least 90% of the epoxy polymer is released into the release agent.

Finally, the at least one fibre mat is retrieved from the disintegrated epoxy composite structure. This is possible due to the separation of the fibre mat and the epoxy resin caused by the release agent, and as described above.

Accordingly, the fibres are retrieved from the epoxy composite structure, in the form of a fibre mat, i.e. a substantially two-dimensional structure, in one piece, where the overall structure of the fibre mat which was originally applied when the epoxy composite structure was manufactured is maintained. This allows the retrieved fibre mat to be readily and directly used for manufacturing a new composite structure of relatively high quality. For instance, it is not necessary to reproduce new fibre mats, or even new fibres, e.g. from remelted fibre material, in order to recycle the fibres. This reduces the environmental impact.

The inventors of the present invention have surprisingly found that exposing the epoxy composite structure to a suitable release agent causes the epoxy composite structure to disintegrate in the manner described above and allows fibre mats to be retrieved in one piece.

The epoxy composite structure may be exposed to the release agent for a suitable period of time, such as a period of time which is sufficiently long to allow the release agent to cause the desired disintegration of the epoxy composite structure.

The at least one retrieved fibre mat may comprise oriented fibres. This could, e.g., include unidirectional fibres, bidirectional fibres, woven fibres, otherwise oriented fibres, etc. According to this embodiment, the orientation of the fibres defined in the originally applied fibre mat is maintained in the retrieved fibre mat. Thus, the fibres of the retrieved fibre mat follow a well-defined orientation or pattern, which can be relied upon when the retrieved fibre mat is used in a new composite structure.

As an alternative, the fibres of the retrieved fibre mat may be randomly oriented or non-oriented. In this case the structure of the retrieved fibre mat may for example be similar to veil or felt.

The release agent may comprise acid. According to this embodiment, the epoxy resin is preferably of a kind which is acid breakable, in the sense that the epoxy resin comprises epoxy polymer which is capable of swelling upon exposure to an acid containing release agent to mechanically break some of the chemical bonds, or which is capable of chemically disassemble into monomers and/or oligomers.

The release agent may, e.g., comprise formic acid. Formic acid is readily available at low cost. Furthermore, formic acid is considered safe to humans as well as with regard to the environment. Finally, the inventors of the present invention have found that formic acid is an efficient release agent with respect to epoxy resins applied in some relevant epoxy composite structures, such as certain wind turbines blades. Accordingly, formic acid is a suitable, safe, and cost effective choice for the release agent.

When the release agent comprises formic acid, it is preferred that the matrix of epoxy resin is based on an amine cured epoxy resin as formic acid was found to readily cause disintegration of the matrix of amine cured epoxy resins to release fibre mats of the composite structure. Particularly, no oxidative effect of the release agent was required to disintegrate the matrix of the epoxy resin in this case.

The at least one retrieved fibre mat may comprise less than 4 wt-% epoxy resin. Such small amounts of residual resin will typically be acceptable, particularly when the residual resin is bonded to the surface of the fibre mats. Small amounts of residual resin may in some cases act as a sizing in that new resin of similar type may bond easily to the particles and hence may lead to a better overall bonding between new resin and the fibres of the retrieved fibre mat. However, it is preferred that the at least one retrieved fibre mat comprise very little residual resin such as less than 1 wt-% epoxy resin and more preferably the at least one retrieved fibre mat comprises less than 0.5 wt-% epoxy. Reduction of the residual epoxy resin may require post treatment after the disintegration by the release agent, such as mechanical or chemical post treatment, and it may be preferred that the fibre mats comprise substantially no residual epoxy resin.

As an alternative, the release agent may comprise other suitable kinds of acid, such as acetic acid.

The release agent may further comprise a surfactant, a solvent and/or a complexing agent.

The step of exposing the epoxy composite structure to a release agent may cause swelling of epoxy polymers of the epoxy resin and cause the epoxy resin to disintegrate into swelled epoxy particles and releasing of the at least one fibre mat.

According to this embodiment, the release agent may be regarded as a swelling agent. When the cured epoxy resin is exposed to such a swelling agent, epoxy polymers forming part of the epoxy resin will swell, and the epoxy resin thereby disintegrates, e.g. due to mechanical breaking of some of the chemical bonds of the epoxy resin. As a result, a slurry may, e.g., be formed of the release agent and the swelled epoxy polymer particles. Accordingly, the at least one fibre mat is released from the epoxy polymer matrix, and the fibre mat can be readily retrieved in one piece.

As an alternative, the release agent may cause the epoxy resin to chemically disintegrate, e.g. into monomers and/or oligomers. This will also result in the at least one fibre mat being released from the epoxy polymer matrix, allowing it to be readily retrieved in one piece.

The step of retrieving the at least one fibre mat may comprise retrieving the at least one fibre mat from a mix of release agent and treated composite material. As described above, exposing the epoxy resin to the release agent may cause the epoxy resin to swell or disintegrate, and a mix, e.g. in the form of a slurry, may be formed of the release agent and the treated composite material, notably the treated epoxy resin. Accordingly, the mix of release agent and treated composite material may comprise swelled epoxy particles, as described above.

The epoxy composite structure may be a wind turbine blade or a part of a wind turbine blade. According to this embodiment, the method according to the invention may be applied for recycling wind turbine blades which have reached their end of life or have been damaged. The method may be formed on a complete wind turbine blade. As an alternative, the wind turbine blade may be cut into a number of smaller pieces before exposing the wind turbine blade to the release agent, for example in order to allow for easier handling, transportation and/or initial separation e.g. in groups of pieces having mats with different types of fibres or fibre orientation.

It is preferred that the size of the retrieved recyclable fibre mat is of a size that facilitate reuse including possible orientation of the fibre mats during arrangement in a mould for resin infusion. In some examples, the fibre mat has an area of at least 100 cm² corresponding to for example at least 10 cm×at least 10 cm. Smaller mats with areas of down to about 100 cm² may typically be used with random layup in larger moulds or for very small new composites, such as carrier layer in printed circuit boards, PCB. Preferably, the area of mat is at least 2500 cm² such as at least 50 cm×at least 50 cm. However, larger pieces such as at least 1 m² are in most applications preferred, as this allows for easily taking into consideration the orientation of the fibres of the mats when arranging the fibre mats during reusing the recycled fibre mats. For practical reasons, it is preferred that the width of the fibre mat is less than 2 meters as larger sizes may be complicated to handle. In general, if a wind turbine blade or any other composite structure being recycled are cut prior to into smaller pieces before exposing to the release agent, then the arrangement of the cuts and the size of the smaller pieces are preferably made taking into consideration the resulting size of the recyclable fibre mats that will be retrieved by the method of the present invention. In one example, the size and/or shape of the recycled fibre mats are standardized, such as squares of 10 cm×10 cm, 25 cm×25 cm, 50 cm×50 cm or rectangular, such as 10 cm×100 cm or 25 cm×100 cm. Using a standardized size and/or shape allows for easier design of layups that may overcome the need for characterising of each recycled fibre mat individually, for example by arranging the fibre mats of standardized size and/or shape in multiple layers such as at least 10 layers in composite structures.

One aspect of the invention therefore concerns a group of fibre mats according to the first aspect of the invention, wherein all fibre mats of the group have the same size and/or shape. The group may comprise at least 100 mats, such as at least 1000 mats. Recycled fibre mats having standardized size and/or shapes may also facilitate mixing of fibre mats from different sources for retrieving of fibre mats. In one example, the group of recycled fibre mats of standardized size and/or shape are of relatively small size, such as having dimensions of less than 25 cm×less than 25 cm. Such small size of standardized fibre mats may allow for layers of fibre mats being formed by randomly arranging a plurality of such standardized mats in a mould, so there are a certain minimum number of layers (such as at least 10 layers) of fibre mats everywhere in the mould. It was found that such random arrangement of standardized recycled mats provided substantially isotropic properties in the plane of the mould including levelling out variation in quality of the recycled fibre mats. Hence a simple and fast layup is realized providing predictable properties of the final composite structure even if the reused fibre mats exhibited considerable variation in quality.

In some cases, fibre mats of composite structures were stitched together into stacks of fibre mats prior to application of epoxy resin to the composite structures. Then it was found to be advantageous that the method further comprises the step of remove the stitching between the fibre mats. Stitching is preferably removed prior to the optional classification of the fibre mats. Removing of the stitching may be manually or automated for example using a robot after identification of the stitching using a vision system.

The retrieved at least one fibre mat may comprise oriented glass fibres and/or oriented carbon fibres. Since the fibre mat is retrieved directly from a composite material, no virgin fibres were required to the preparation and hence no extra energy for melting and forming fibres and were used. Furthermore, landfill of the composite material was prevented, and the epoxy part of the composite may even be recycled and reused in a separate process. Hence the recycled fibre mat is environmentally highly advantageous over virgin fibre mats of similar size.

The method may further comprise the step of reusing the retrieved at least one fibre mat in a new composite structure. According to this embodiment, the retrieved fibre mat is directly reused, e.g. without remelting of glass fibres and/or without realigning fibres in mats for example by weaving or stitching, in a new composite structure. This reduces the environmental footprint of the new composite structure because it is not necessary to spend energy for forming a new fibre mat. Furthermore, the need for virgin material resources for manufacturing the new composite structure is reduced, because the material of the retrieved fibre mat is reused.

The method may further comprise the step of preparing the retrieved at least one fibre mat for reuse. This could, e.g., include adding sizing, primer and/or another suitable agent to a surface of the fibres of the fibre mat, in order to improve the properties of the fibre mat in terms of adherence to a resin of a new composite structure, which the retrieved fibre mat is intended to form part of. Alternatively or additionally, other suitable kinds of treatment may be applied, e.g. adding colour.

The method may further comprise the step of chemically and/or mechanically cleaning the retrieved at least one fibre mat. According to this embodiment, residues from the original epoxy composite structure, such as residues of the matrix of epoxy resin, are removed from the retrieved at least one fibre mat, in order to put it improve the fibre surface for reuse purposes. Chemical cleaning of the fibre mat may, e.g., include applying a solvent, a release agent, or the like to the retrieved fibre mat. This may, e.g., cause epoxy particles being stuck to the fibres of the fibre mat to chemically break and/or be released from the fibres. Mechanical cleaning of the fibre mat may, e.g., include washing, e.g. by applying water, and possibly surfactant or soap, rubbing, rolling, bending, compressing, applying a pressurized fluid, e.g. water or air, etc. Such mechanical cleaning may, e.g., cause epoxy particles being stuck to the fibres of the fibre mat to mechanically break and/or be mechanically released from the fibres.

The method may further comprise the step of drying the retrieved at least one fibre mat. According to this embodiment, any release agent which may be sucked up by the fibres of the fibre mat are dried off before the fibre mat is reused.

The method may further comprise the step of categorising the retrieved at least one fibre mat according to quality, fibre orientation, fibre type and/or size of the fibre mat. Such categorisation may, e.g., be applied as a basis for sorting retrieved fibre mats, with the purpose of deciding how to reuse the retrieved fibre mats, including which fibre mats to use for which new composite structures and/or where in a new composite structure a given fibre mat may be suitably positioned.

The quality of the retrieved fibre mats could, e.g., be evaluated based on degree of wear, fibre breakage and/or amount of residue material stuck to the fibres, e.g. bonded to a surface of the fibres.

According to a second aspect the invention provides a fibre mat, wherein the fibre mat is a recycled fibre mat and comprises epoxy particles chemically and/or mechanically bonded to a surface of the fibre mat. Thus, the fibre mat according to the second aspect of the invention is recycled, in the sense that it has previously formed part of a composite structure, e.g. an epoxy composite structure, and in the sense that the fibre mat has been retrieved from the previous composite structure. As a consequence thereof, residues from the previous composite structure, in the form of epoxy particles, are chemically and/or mechanically bonded to a surface of the fibre mat. It was found that presence of smaller epoxy particles did to influence the properties of the new composite prepared from the recycled mats when the particles were small. Preferably, the particles have a maximum dimension of 3-50 μm. In some cases, smaller bonded particles of residual resin may work as a sizing in that the properties may even improve due to new resin forming a strong bond to the residual resin particles bonded to the surface of the fibre mats. In some cases, the size of the particles is about the order of the diameter of the fibres of the recycled fibre mat. Hence, it for fibre mats with carbon fibres, it was found to be advantageous that particles of residual resin having a maximum dimension of 3-15 μm are present. For fibre mats with glass fibres, it was found to be advantageous that particles of residual resin having a maximum dimension of 10-50 μm are present.

The fibre mat may have been retrieved from an epoxy composite structure in accordance with a method according to the first aspect of the invention, and as described above. Accordingly, the remarks set forth above with reference to the first aspect of the invention are equally applicable here.

The fibre mat may comprise oriented fibres, such as unidirectional fibres, bidirectional fibres, woven fibres, otherwise oriented fibres, etc. This has already been described above with reference to the first aspect of the invention. The oriented fibres may, e.g., be glass fibres and/or carbon fibres.

The fibre mat may form part of a new composite structure. According to this embodiment, the fibre mat has been reused directly, in its retrieved form, in a new composite structure. In particular, any orientation and configuration of the fibres of the fibre mat is maintained as in the original fibre mat.

### BRIEF DESCRIPTION OF THE DRAWINGS

The invention will now be described in further detail with reference to the accompanying drawings in which

FIG. 1 is a perspective view of a wind turbine,

FIGS. 2 and 3 illustrate a wind turbine blade to be processed in accordance with a method according to an embodiment of the invention,

FIGS. 4-7 illustrate steps of a method according to an embodiment of the invention, and

FIG. 8 illustrate steps of a method according to an alternative embodiment of the invention.

### DETAILED DESCRIPTION OF THE DRAWINGS

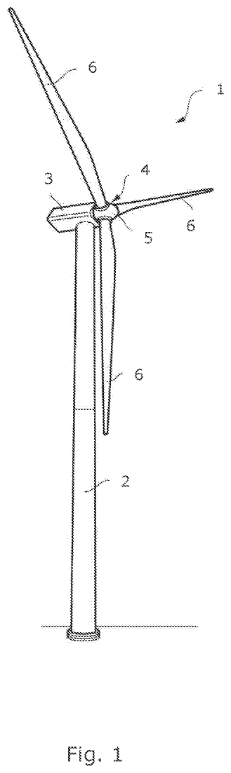

FIG. 1 is a perspective view of a wind turbine 1 comprising a tower 2 and a nacelle 3 mounted on top of the tower 2. A rotor 4 with a hub 5 carrying three wind turbine blades 6 is mounted rotatably on the nacelle 3. Accordingly, wind acting on the wind turbine blades 6 causes the rotor 4 to rotate, and the mechanical energy is transformed into electrical energy by means of a generator (not shown), in a manner which is known per se.

When the wind turbine 1, or one or more components of the wind turbine 1, has reached its end of life, it will be decommissioned. To this end, it is desirable to recycle the material of the various components to the greatest possible extent. In particular, the material of the wind turbine blades 6, which is often a composite material, may advantageously be fully or partly recycled, e.g. by applying a method according to an embodiment of the invention.

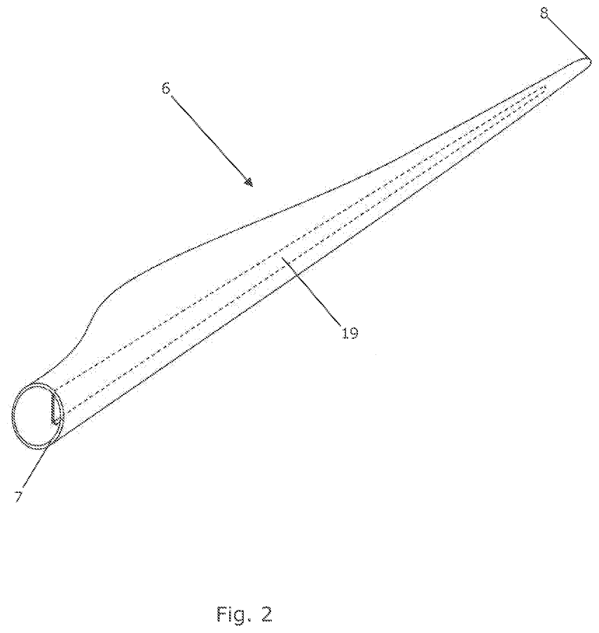

FIG. 2 is a perspective view of an epoxy composite structure in the form of a wind turbine blade 6. The wind turbine blade 6 extends in a longitudinal direction between a root end 7 and a tip end 8. A web 19 extends along the longitudinal direction inside the wind turbine blade 6.

The wind turbine blade 6 of FIG. 2 has been demounted from a wind turbine, and the composite material of the wind turbine blade 6 is about to be at least partly recycled by means of a method according to an embodiment of the invention. This will be described in further detail below.

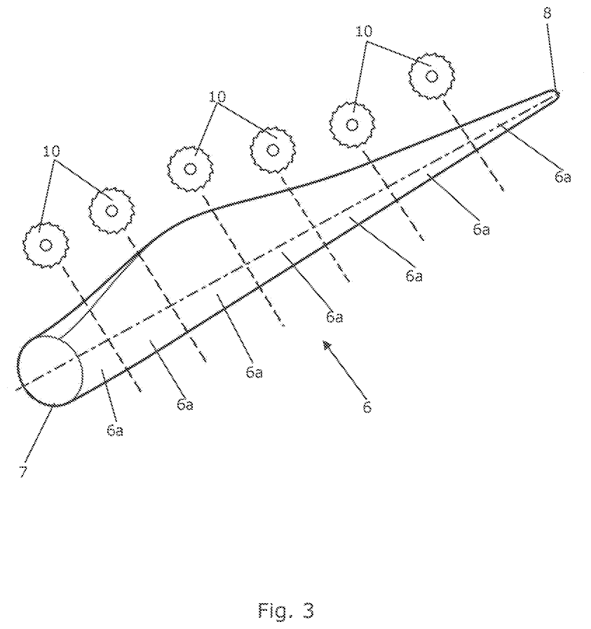

FIG. 3 illustrates the wind turbine blade 6 of FIG. 2 in the process of being cut into smaller parts 6a, the cutting step being illustrated by saw blades 10. The smaller parts 6a are easier to manage than the entire wind turbine blade 6, and each of the smaller parts 6a constitutes a composite structure in the sense of the claimed invention. It should, however, be mentioned that the cutting step illustrated in FIG. 3 is optional, and that the method steps described below could, alternatively, be performed on the intact wind turbine blade 6, as it is illustrated in FIG. 2. Furthermore, the cutting as illustrated in FIG. 3 is conducted so the retrieved mats of the method retain a suitable size for high value reuse.

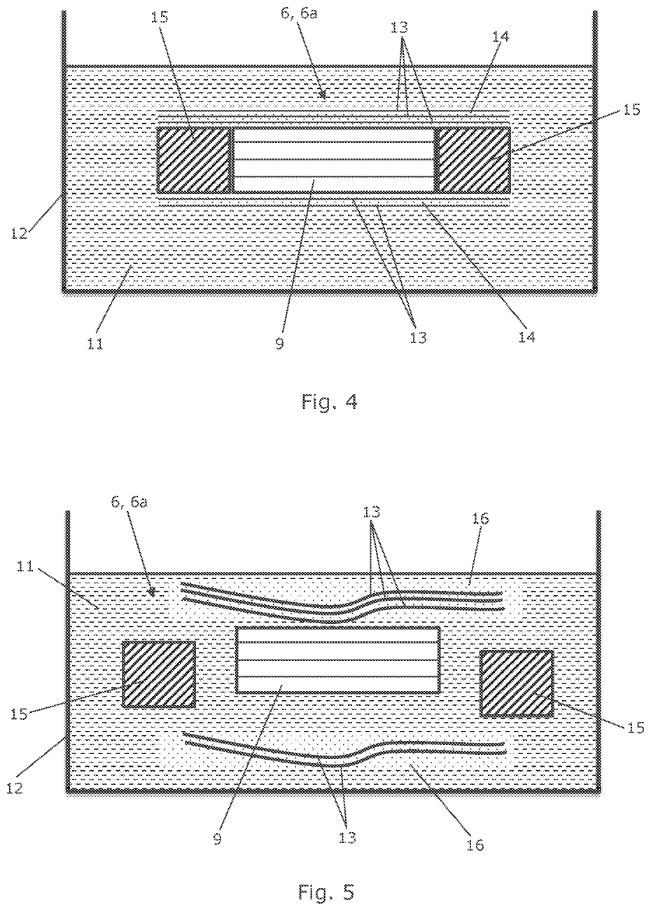

FIGS. 4-7 illustrate method steps of a method according to an embodiment of the invention. In FIG. 4, an epoxy composite structure, in the form of a wind turbine blade 6 or a part 6a of a wind turbine blade, has been submerged in a release agent 11 accommodated in a vessel 12. The epoxy composite structure 6, 6a comprises a plurality of fibre mats 13, five of which are shown, embedded in a matrix of cured epoxy resin 14. The fibre mats 13 may each comprise oriented or random fibres, e.g. glass fibres. Furthermore, the epoxy composite structure 6, 6a comprises two core members 15 and a spar cap 9.

The release agent 11 may comprise acid, such as formic acid, and it acts on the epoxy composite structure 6, 6a in such a manner that the epoxy composite structure 6, 6a disintegrates. More particularly, the release agent 11 causes swelling of epoxy polymers of the epoxy resin 14, and this causes the cured epoxy resin 14 to disintegrate into swelled epoxy particles. This, in turn, releases the fibre mats 13, as well as the core members 15 and the spar cap 9, from the matrix of epoxy resin 14.

In FIG. 5, the release agent 11 has acted on the composite structure 6, 6a for sufficiently long to have caused the disintegration of the composite structure 6, 6a described above with reference to FIG. 4. In particular, it can be seen that the fibre mats 13 are now floating freely in a mix 16 of release agent and disintegrated epoxy resin. Accordingly, the fibre mats 13 may be retrieved in one piece, and with their original fibre orientation, from the mix 16 of release agent and disintegrated epoxy resin.

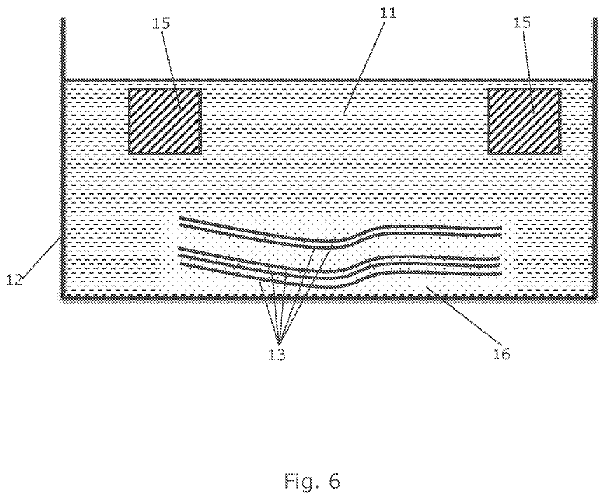

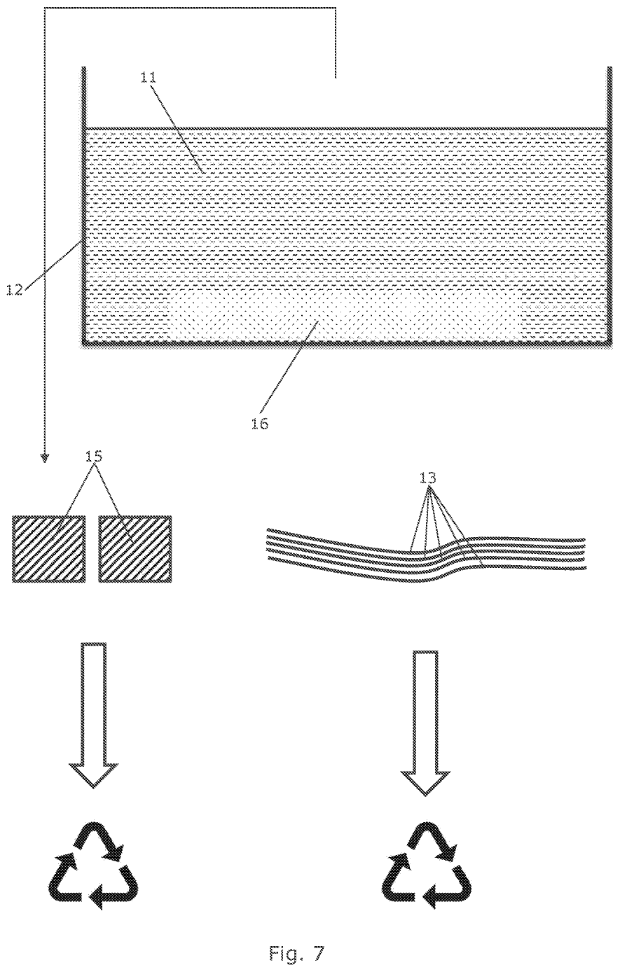

In FIG. 6, the spar cap has been retrieved for separate recycling from the vessel accommodating the release agent 11. The core members 15 have moved upwards towards the surface of the release agent 11 and the top of the vessel, while the mix 16 of release agent and disintegrated epoxy resin has moved downwards towards the bottom of the vessel 12, along with the released fibre mats 13.

In FIG. 7, the core members 15 as well as the fibre mats 13 have been retrieved from the vessel 12 accommodating the release agent 11, and each of these components 13, 15 are now ready for recycling. This could, e.g., include reusing the fibre mats 13 or the core members 15 in their retrieved form, e.g. as components of a new composite structure. As an alternative, the material of the fibre mats 13 or the core members 15 may simply be recycled. This may, e.g., include remelting the fibres of the fibre mats 13.

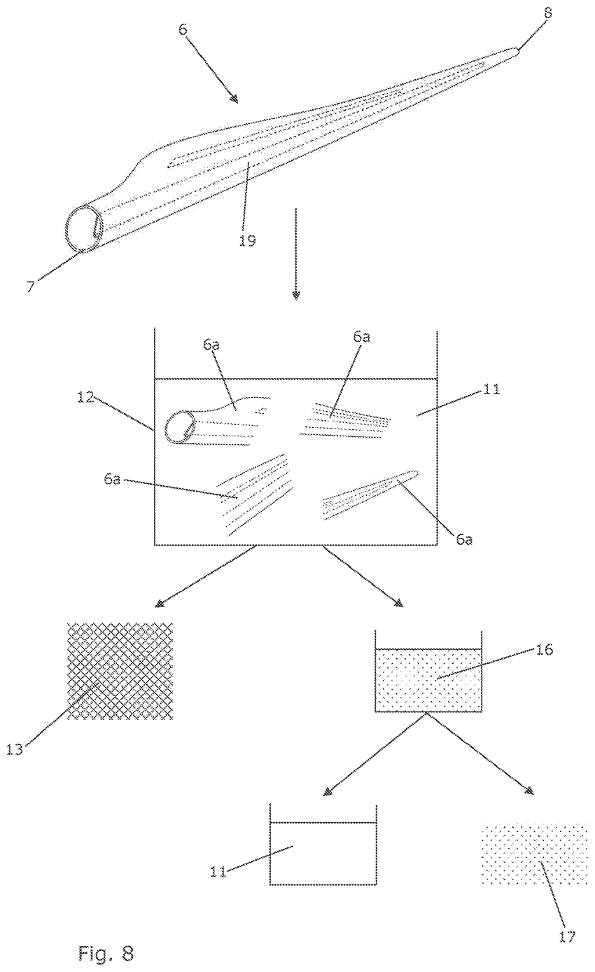

FIG. 8 illustrates method steps of a method according to an alternative embodiment of the invention. A wind turbine blade 6 is initially cut into smaller parts 6a, e.g. in the manner illustrated in FIG. 3. The smaller parts 6a are submerged in a release agent 11 accommodated in a vessel 12. This causes the composite structures, in the form of the smaller parts 6a, to disintegrate, e.g. in the manner described above with reference to FIGS. 4-7. Accordingly, at least one fibre mat 13 is retrieved in one piece, and with its original fibre orientation. This allows the fibre mat 13 to be reused directly, in its retrieved form. In the fibre mat 13 illustrated in FIG. 8, the fibres have a bidirectional orientation. Furthermore, a mix 16 of release agent and epoxy resin is retrieved from the vessel 12. The mix 16 is subsequently separated into release agent 11 and swelled epoxy particles 17. This allows for reuse or recycling of the release agent 11 as well as of the epoxy particles 17.

1. A method for retrieving a recyclable fibre mat from an epoxy composite structure, the method comprising:
providing an epoxy composite structure made from a composite material comprising at least one fibre mat embedded in a matrix of epoxy resin,
exposing the epoxy composite structure to a release agent causing disintegration of the epoxy composite structure, and
retrieving the at least one fibre mat from the disintegrated epoxy composite structure.

2. The method according to claim 1, wherein the at least one retrieved fibre mat comprises oriented fibres.

3. The method according to claim 1, wherein the release agent comprises acid.

4. The method according to claim 3, wherein the release agent comprises formic acid.

5. The method according to claim 1, wherein the at least one retrieved fibre mat comprises less than 4 wt-% epoxy resin, preferably the at least one retrieved fibre mat comprises less than 1 wt-% epoxy resin, more preferably the at least one retrieved fibre mat comprises less than 0.5 wt-% epoxy.

6. The method according to claim 1, wherein exposing the epoxy composite structure to a release agent causes swelling of epoxy polymers of the epoxy resin and causes the epoxy resin to disintegrate into swelled epoxy particles and releasing of the at least one fibre mat.

7. The method according to claim 1, wherein retrieving the at least one fibre mat comprises retrieving the at least one fibre mat from a mix of release agent and treated composite material.

8. The method according to claim 1, wherein the epoxy composite structure is a wind turbine blade or a part of a wind turbine blade.

9. The method according to claim 1, further comprising reusing the retrieved at least one fibre mat in a new composite structure.

10. The method according to claim 9, further comprising the step of preparing the retrieved at least one fibre mat for reuse, preferably by adding sizing or primer to the surface of the fibres of the fibre mat.

11. The method according to claim 1, further comprising chemically and/or mechanically cleaning the retrieved at least one fibre mat.

12. The method according to claim 1, further comprising categorising the retrieved at least one fibre mat according to quality, fibre orientation, fibre type and/or size of the fibre mat.

13. A fibre mat, wherein the fibre mat is a recycled fibre mat and comprises epoxy particles chemically and/or mechanically bonded to a surface of the fibre mat, the epoxy particles having a maximum dimension of 3-50 μm.

14. The fibre mat according to claim 13, wherein the fibre mat has been retrieved from an epoxy composite structure in accordance with a method according to claim 1.

15. The fibre mat according to claim 13, wherein the fibre mat comprises oriented fibres.

16. The fibre mat according to claim 1, wherein the fibre mat forms part of a new composite structure.

17. (canceled)
